(19) United States
(12) Patent Application Publication
(10) Pub. No.: US 2024/0344737 A1
(43) Pub. Date: Oct. 17, 2024

(54) FILTER MODULE AND AIR PURIFIER COMPRISING SAME

(71) Applicant: COWAY CO., LTD., Gongju-si (KR)

(72) Inventors: Yoon Hyuck CHOI, Seoul (KR); Jong Cheol KIM, Seoul (KR); Hyun Kyu LEE, Seoul (KR); Woo Ram KIM, Seoul (KR); Dong Won JEONG, Seoul (KR); Ju Hyun BAEK, Seoul (KR)

(73) Assignee: COWAY CO., LTD., Gongju-si (KR)

(21) Appl. No.: 18/294,255

(22) PCT Filed: Aug. 1, 2022
(86) PCT No.: PCT/KR2022/011272

§ 371 Date: Feb. 1, 2024

(30) Foreign Application Priority Data
Aug. 4, 2021 (KR) 10-2021-0102497

(51) Int. Cl. F24F 13/28; F24F 8/108; F24F 8/80; F24F 13/20

(52) U.S. Cl. CPC F24F 13/28; F24F 8/108; F24F 8/80; F24F 13/20; F24F 2013/205

(57) ABSTRACT

A filter module mounted on an air purifier to filter air includes a first filter unit and a second filter unit detachably connected to the first filter unit and arranged to surround the first filter unit. The first filter unit includes a shape-corresponding portion having at least a portion which is formed in a curved shape having a predetermined curvature. At least a portion of the edge of the second filter unit is formed in a shape corresponding to the shape-corresponding portion, and when the filter module is mounted on the air purifier, the amount of air passing through the first filter unit per unit area is greater than the amount of air passing through the second filter unit per unit area.

### TECHNICAL FIELD

The present disclosure relates to a filter module and an air purifier including the filter module.

### BACKGROUND ART

Generally, an air purifier is a device that draws polluted indoor air, removes dust and odor particles contained in the air using a filter, and purifies the air, producing clean air. The air purifier can purify indoor air by drawing and purifying the surrounding polluted air and then discharging the purified clean air to the outside of the air purifier.

Further, the air purifier may include a blower that introduces external air into the air purifier, and a filter that removes dust and odor particles from the introduced air.

Meanwhile, the air passing through the filter by the blower does not flow at a uniform flow rate across the entire surface of the filter. A portion of the filter where air flows quickly can filter a larger amount of air than a portion where air flows slowly. The more air the portion filters, the more the filtration capacity is decreased. In other words, even when the average filtration capacity of the filter decreases and the filter needs to be replaced, the filtration capacity of the portion that filters slow-flowing air does not decrease significantly. Nevertheless, since the portion where air flows quickly and the portion where air flows slowly are formed integrally with each other in the conventional filter, the portion with less reduced filtration capacity is replaced along with the portion with significantly reduced filtration capacity when the filter is replaced.

In this regard, Korean Patent Application Publication No. 10-2015-0032989 entitled “Air purifier having the function of hot air blowing” (Patent Document 1) of the applicant discloses an air purifier including a blowing fan and a plurality of filters.

Further, Korean Patent Application Publication No. 10-2016-0099145 entitled “Air purifier” (Patent Document 2) of the applicant discloses an air purifier including a blowing fan and a plurality of filters.

However, Patent Document 1 and Patent Document 2 are problematic in that, when the filter is replaced, the portion of the filter with significantly reduced filtration capacity and the portion with less reduced filtration capacity are replaced at the same time, so even the portion with less reduced filtration capacity is replaced and discarded.

### PRIOR ART DOCUMENT

(Patent Document 1) Korean Patent Application Publication No. 10-2015-0032989 (published on Apr. 1, 2015)
(Patent Document 2) Korean Patent Application Publication No. 10-2016-0099145 (published on Aug. 22, 2016)

### DETAILED DESCRIPTION OF INVENTION

### Technical Problems

The present disclosure has been made keeping in mind the above problems, and an objective of the present disclosure is to provide an air purifier including a filter module in which a first filter unit and a second filter unit can be separated from each other.

The present disclosure provides an air purifier configured so that the amount of air passing through the first filter unit per unit area is greater than the amount of air passing through the second filter unit per unit area.

### Technical Solution

In accordance with one embodiment of the present disclosure, a filter module installed in an air purifier to filter air comprises a first filter unit; and a second filter unit detachably connected to the first filter unit and arranged to surround at least a portion of the first filter unit, wherein the first filter unit comprises a shape-corresponding portion having at least a portion which is formed in a curved shape having a predetermined curvature, at least a portion of an edge of the second filter unit is formed in a shape corresponding to the shape-corresponding portion, and when the filter module is installed in the air purifier, an amount of air passing through the first filter unit per unit area is greater than an amount of air passing through the second filter unit per unit area.

Further, the first filter unit may comprise an engaging portion, the second filter unit may comprise a fixing portion to engage with the engaging portion, and the engaging portion and the fixing portion may have a shape of a hook or a hole that engages with the hook.

Further, the first filter unit may move relative to the second filter unit in a predetermined fastening direction to be fastened to the second filter unit, and the engaging portion and the fixing portion may be configured to limit movement in the fastening direction when the first filter unit engages with the second filter unit, and the fastening direction may be parallel to a direction in which the air passes through the first filter unit and the second filter unit.

Further, the first filter unit and the second filter unit may contain different filter materials to filter different particles.

Further, the first filter unit may further comprise a first stepped portion that extends along at least a portion of an edge thereof, the second filter unit may comprise a second stepped portion that is formed along at least a portion of the edge thereof to be fastened to the first stepped portion, the first stepped portion and the second stepped portion may have corresponding shapes to prevent air from flowing between the first filter unit and the second filter unit, when the first and second stepped portions are fastened to each other.

Further, at least a portion of the first stepped portion and at least a portion of the second stepped portion may be arranged to overlap each other in an air flow direction.

Further, an air purifier may comprise a filter module according to any one above; and a blower may provide a blowing force to cause external air to flow into the air purifier.

Further, the blower may comprise: a blade rotatably driven; and a blowing frame having an inlet port through which air is introduced by driving the blade, the first filter unit may be configured such that an area where the inlet port is projected onto the first filter unit is located in the shape-corresponding portion.

### Effect of Invention

According to one embodiment of the present disclosure, the filter can be separated into a plurality of filter units, so that only the filter unit with significantly reduced filtration capacity can be replaced among the plurality of filter units, and the filter unit with less reduced filtration capacity can continue to be used.

### BRIEF DESCRIPTION OF THE DRAWING

FIG. 1 is a perspective view showing an air purifier according to a first embodiment of the present disclosure.

FIG. 2 is an exploded perspective view showing the air purifier of FIG. 1.

FIG. 3 is a perspective view showing a filter module of the air purifier of FIG. 1.

FIG. 4 is an exploded perspective view showing the filter module of FIG. 3.

FIG. 5 is a plan view showing a first filter unit of the filter module of FIG. 3.

FIG. 6 is an enlarged view showing part A of FIG. 4.

FIG. 7 is an enlarged view showing part B of FIG. 4.

FIG. 8 is a sectional view taken along line VIII-VIII of FIG. 3.

FIG. 9 is a perspective view showing a filter module of an air purifier according to a second embodiment of the present disclosure.

FIG. 10 is an exploded perspective view showing the filter module of FIG. 9.

FIG. 11 is an exploded perspective view showing a filter module of an air purifier according to a third embodiment of the present disclosure.

FIG. 12 is a side view showing a state in which the filter module of the air purifier according to the third embodiment of the present disclosure is assembled.

### BEST MODE FOR CARRYING OUT THE INVENTION

Hereinafter, specific embodiments for embodying the technical idea of the present disclosure will be described in detail with reference to the drawings.

In addition, if it is decided that the detailed description of known configuration or function related to the present disclosure makes the subject matter of the present disclosure unclear, the detailed description thereof is omitted.

When it is described that a component is “connected” to or “supported” by another component, it should be understood that one component may be directly connected to or supported by another component, but that other components may also exist between them.

The terminology used herein is for the purpose of describing particular embodiments only and is not intended to be limiting. In the present disclosure, the singular forms are intended to include the plural forms as well, unless the context clearly indicates otherwise.

Further, it is to be noted that the expressions “upper”, “lower”, and “side” are described on the basis of the accompanying drawings, and may be differently expressed if the orientation of the subject object changes. For the same reason, some components shown in the drawings may be exaggerated, omitted, or schematically shown, and each component is not shown in an actual size.

It will be understood that, although the terms “first”, “second”, etc. may be used herein to describe various components, these components should not be limited by these terms. These terms are only used to distinguish one component from another component.

It will be further understood that the term “comprise or include” when used in this specification, specifies the presence of stated features, areas, integers, steps, operations, elements, and/or components but do not preclude the presence or addition of other features, areas, integers, steps, operations, elements, components, and/or combinations thereof.

Hereinafter, an air purifier 1 according to a first embodiment of the present disclosure will be described with reference to the drawings.

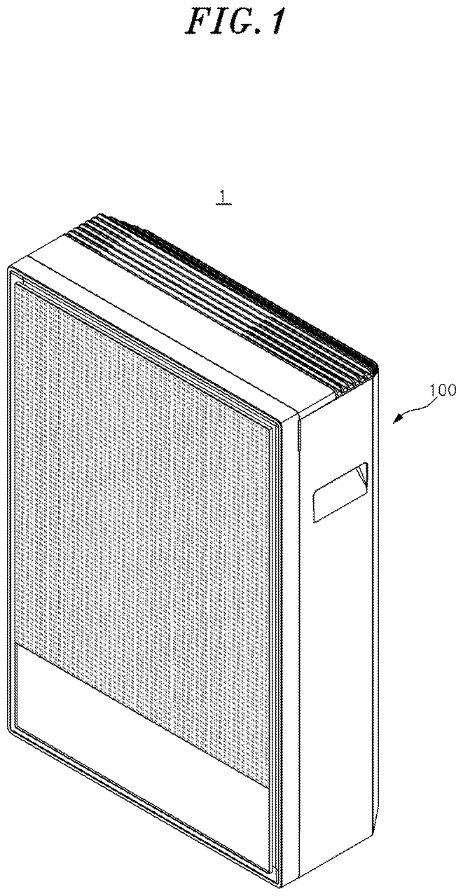

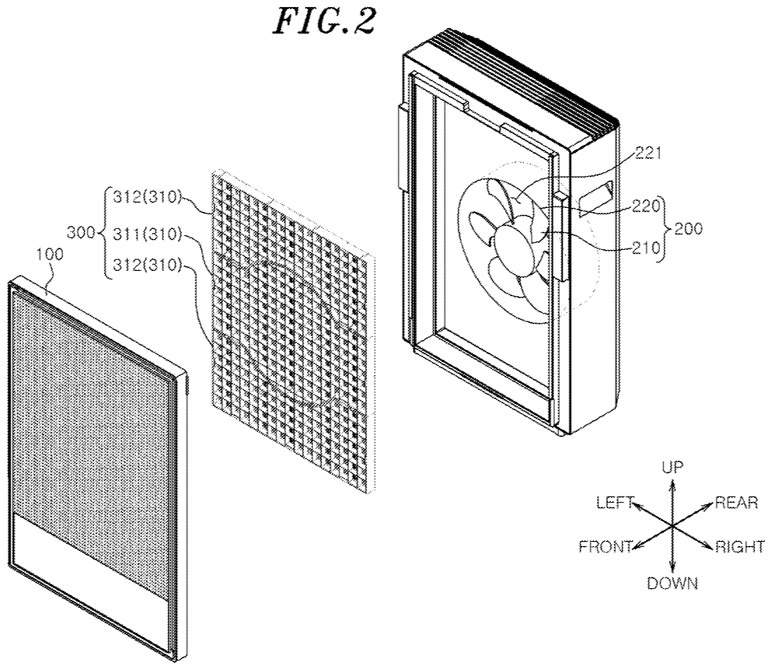

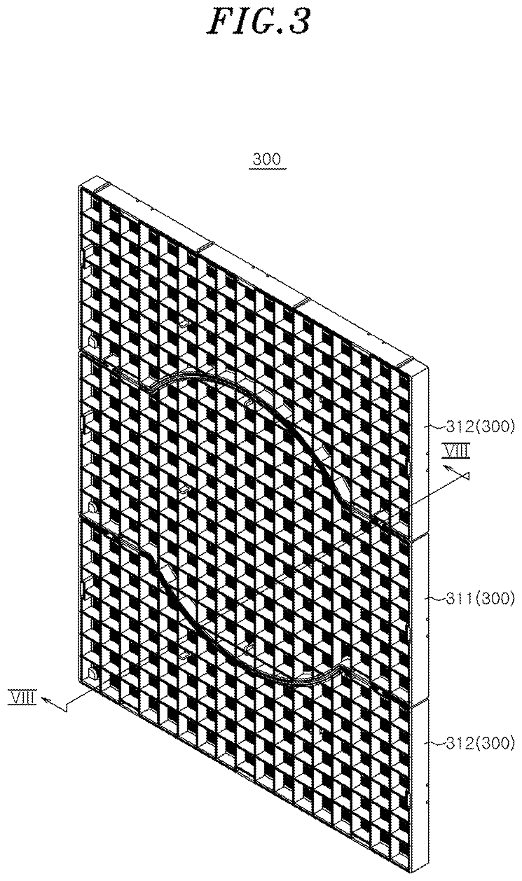

Referring to FIGS. 1 to 3, the air purifier 1 according to the first embodiment of the present disclosure may purify polluted air into clean air by filtering out dust, odor particles, etc. from the air introduced into the air purifier 1. Further, the air purifier 1 may draw in air from outside the air purifier 1 and discharge the clean air purified therein to the outside. Such an air purifier 1 may include a body 100, a blower 200, and a filter module 300.

The body 100 may accommodate the blower 200 and the filter module 300 therein. The body 100 may be formed in a hexahedral shape, but is not limited thereto. Further, an intake port for introducing external air and an outlet port for discharging filtered air may be formed on the body 100. For example, the intake port may be formed on a front surface of the body 100, and the outlet port may be formed on an upper surface of the body 100. By this body 100, the external air may be introduced into the body 100 through the intake port to be filtered by the filter module 300, and then discharged to the outside through the outlet port.

The blower 200 may cause the external air to flow into the body 100 and provide blowing force to discharge the air filtered by the filter module 300 to the outside. Further, the blower 200 may be supported by the body 100. Such a blower may include a blade 210 and a blowing frame 220.

The blade 210 may be accommodated in the blowing frame 220 to be rotatably driven. Such a blade 210 may provide blowing force that causes the external air to flow into the body 100 and discharges the filtered air to the outside.

An inlet port 221 may be formed on the blowing frame 220 to introduce air by driving the blade 210. The clean air filtered by the filter module 300 may be introduced into the inlet port 221.

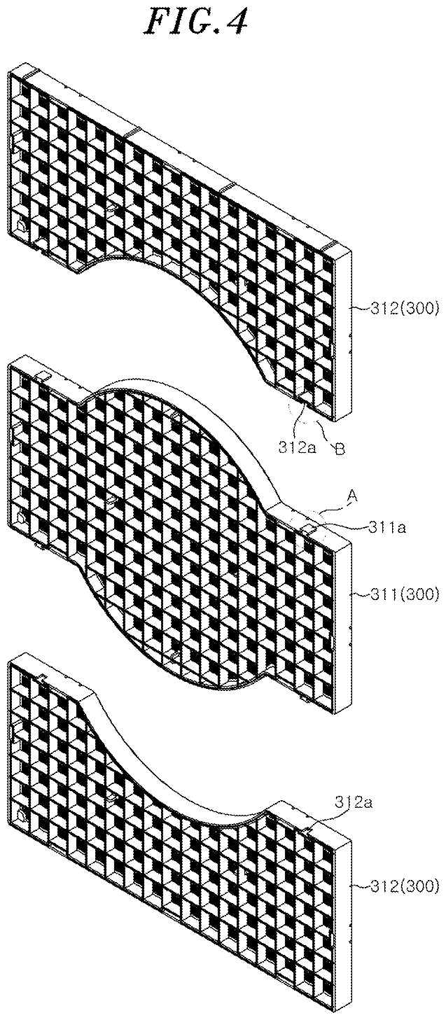

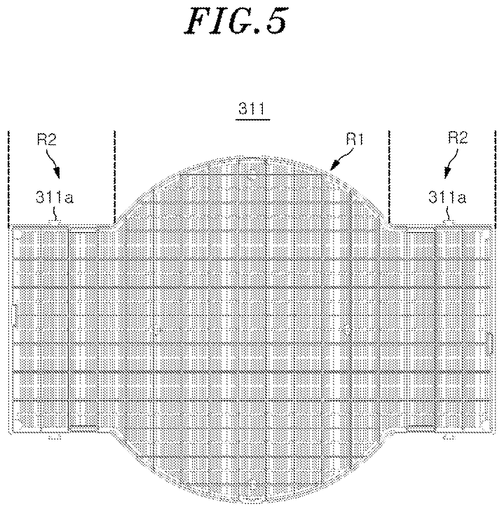

Referring to FIGS. 4 and 5, the filter module 300 may filter the external air into the clean air. For example, the filter module 300 may include well-known filters such as a HEPA filter or a deodorizing filter so as to filter out dust and odor particles in the air. Further, the filter module 300 may be disposed in a position corresponding to the blower 200 when installed in the body 100. For example, the filter module 300 may be disposed between the inlet port and the blower 200. The filter module 300 may include a plurality of filter units 310 that are detachably connected to each other. In other words, a user may replace the plurality of filter units 310 by separating some filter units from others. The plurality of filter units 310 may include a first filter unit 311 and a second filter unit 312. Further, the first filter unit 311 and the second filter unit 312 may contain different filter materials that filter out different particles.

The first filter unit 311 and the second filter unit 312 may be detachably connected to each other. The first filter unit 311 may engage with the second filter unit 312 by moving the first filter unit relative to the second filter unit 312 in a predetermined fastening direction. The fastening direction may be the same as the flow direction of air passing through the filter module 300 when the filter module 300 is installed in the body 100. In other words, the filter module 300 may be disposed so that air flows in the fastening direction by the blower 200. Further, the first filter unit 311 may be disposed closer to the blower 200 than the second filter unit 312. The amount of air passing through the first filter unit 311 per unit area may be greater than the amount of air passing through the second filter unit 312 per unit area. The first filter unit 311 may include a shape-corresponding portion R1 and a connecting portion R2.

When the filter module 300 is installed in the body 100, the shape-corresponding portion R1 faces the blower and may have a shape corresponding to that of the inlet port 221 of the blower 200. In other words, at least a portion of the shape-corresponding portion R1 may have a curved shape with a predetermined curvature along a circumferential direction of the inlet port 221 of the blower 200. By the shape-corresponding portion R1, the first filter unit 311 may be disposed so that an area where the inlet port 221 of the blower 200 is projected onto the first filter unit 311 is located in the shape-corresponding portion R1. In other words, the diameter of the shape-corresponding portion R1 may be greater than the diameter of the inlet port 221 of the blower 200, but the present disclosure is not limited thereto. Further, the amount of air passing through the shape-corresponding portion R1 per unit area is greater than the amount of air passing through the connecting portion R2 per unit area.

The connecting portion R2 may extend in one direction from the shape-corresponding portion R1. In other words, when the filter module 300 is installed in the body 100, the connecting portion R2 may extend from the shape-corresponding portion R1 in a direction perpendicular to the fastening direction. Further, a plurality of connecting portions R2 may be formed. When the filter module 300 is installed in the body 100, the connecting portion R2 may be positioned at a greater distance from the blower 200 than the shape-corresponding portion R1.

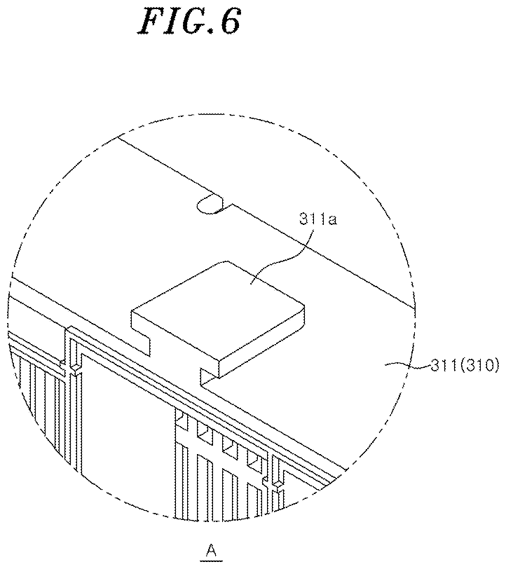

Referring to FIG. 6, an engaging portion 311a may be formed on the first filter unit 311. The engaging portion 311a may engage with a fixing portion 312a of the second filter unit 312, which will be described later. By the engaging portion 311a, the first filter unit 311 may be separated from or coupled to the second filter unit 312. The engaging portion 311a and the fixing portion 312a may have the shape of a hook and a hole that may engage with the hook. For example, when the first filter unit 311 is coupled to the second filter unit 312, the engaging portion 311a may protrude from the first filter unit 311 toward the second filter unit 312. Further, the engaging portion 311a and the fixing portion 312a may be configured to limit movement in the fastening direction when the first filter unit 311 engages with the second filter unit 312. In other words, when the engaging portion 311a is engaged with the fixing portion 312a by moving in the fastening direction, a further movement in the fastening direction may be limited by the fixing portion 312a. Such an engaging portion 311a may be formed on the edge of either of the shape-corresponding portion R1 and the connecting portion R2.

The second filter unit 312 may be detachably connected to the first filter unit 311, and be disposed to surround the first filter unit 311. Further, a plurality of second filter units 312 may be provided. The first filter unit 311 may be disposed between the plurality of second filter units 312. For example, when the filter module 300 is installed in the body 100, one of the plurality of second filter units 312 may be disposed above the first filter unit 311, and the other may be disposed under the first filter unit 311.

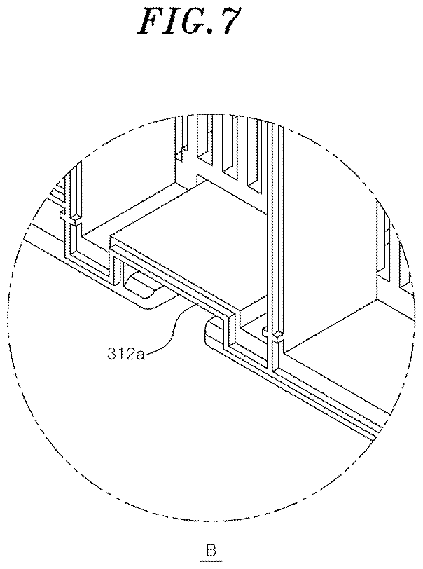

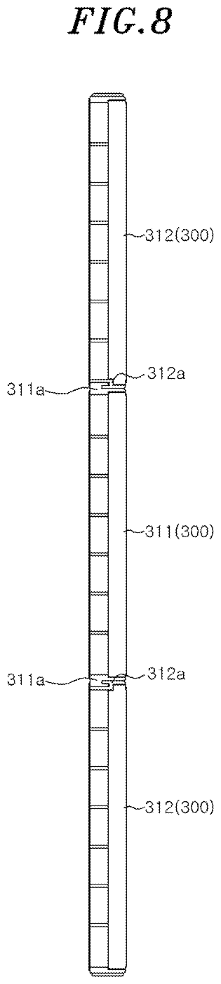

Referring to FIGS. 7 and 8, the fixing portion 312a may be formed on the second filter unit 312 to engage with the engaging portion 311a. For example, the fixing portion 312a may provide a hole into which the engaging portion 311a may be inserted. Such a fixing portion 312a may limit the movement of the first filter unit 311 in the fastening direction when the filter module 300 is installed in the body 100.

Hereinafter, the operation and effects of the air purifier 1 according to the first embodiment of the present disclosure will be described.

Since the filter module 300 according to the embodiment of the present disclosure may be composed of the plurality of filter units 310 that are detachably connected to each other, a user can replace at least one of the plurality of filter units 310.

Further, since the amount of air passing through the first filter unit 311 per unit area is greater than the amount of air passing through the second filter unit 312 per unit area, the filtration performance of the first filter unit 311 may deteriorate faster than that of the second filter unit 312. In other words, a user can efficiently use the filter module 300 by replacing the first filter unit 311 whose filtration performance deteriorates, excluding the second filter unit whose filtration performance does not deteriorate.

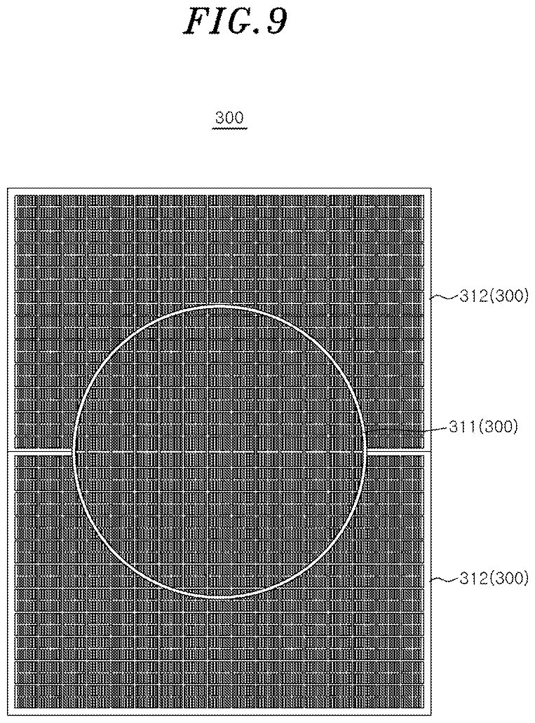

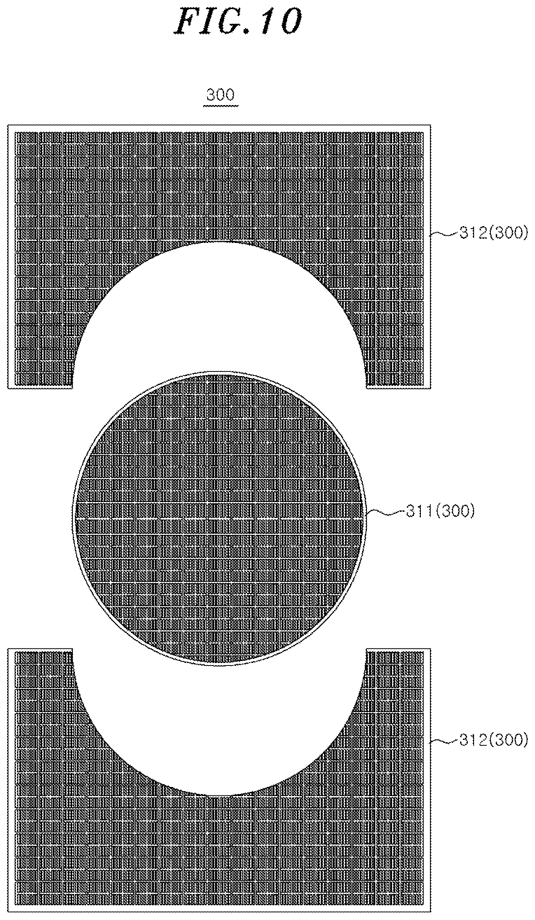

Hereinafter, an air purifier 1 according to a second embodiment of the present disclosure will be described with reference to FIGS. 9 and 10. The second embodiment is different from the above-described first embodiment in that the first filter unit 311 may include only the shape-corresponding portion R1. The following description focuses on explaining the differences, and the same description and reference numerals will refer to those in the above-described embodiment.

Since the first filter unit 311 includes only the shape-corresponding portion R1, it may be formed in a shape corresponding to that of the blower 200. In other words, the first filter unit 311 may have a shape corresponding to that of at least a portion of the edge of the second filter unit 312. The first filter unit 311 may be formed, for example, in a circular shape, an elliptical shape, or a shape similar to the circular shape. The edge of the first filter unit 311 may be surrounded by the second filter unit 312 when the first filter unit 311 is fastened to the second filter unit 312. Further, the filter module 300 may be installed in the body 100 such that the first filter unit 311 is placed in an area where the blower 200 is projected onto the filter module 300.

As an example, an opening in which the first filter unit 311 may be disposed may be formed in the second filter unit 312. As another example, a plurality of second filter units 312 may be provided to surround the first filter unit 311. Further, the plurality of second filter units 312 may be coupled to or separated from each other.

Hereinafter, the operation and effects of the air purifier 1 according to the second embodiment of the present disclosure will be described.

Since the first filter unit 311 may be placed in the area where the blower 200 is projected onto the filter module 300 when the filter module 300 of the air purifier 1 according to the second embodiment is installed in the body 100, the amount of air filtered by the first filter unit 311 may be uniform. In other words, since the first filter unit 311 may be replaced when the overall filtration performance thereof deteriorates, a user can efficiently use the filter module 300.

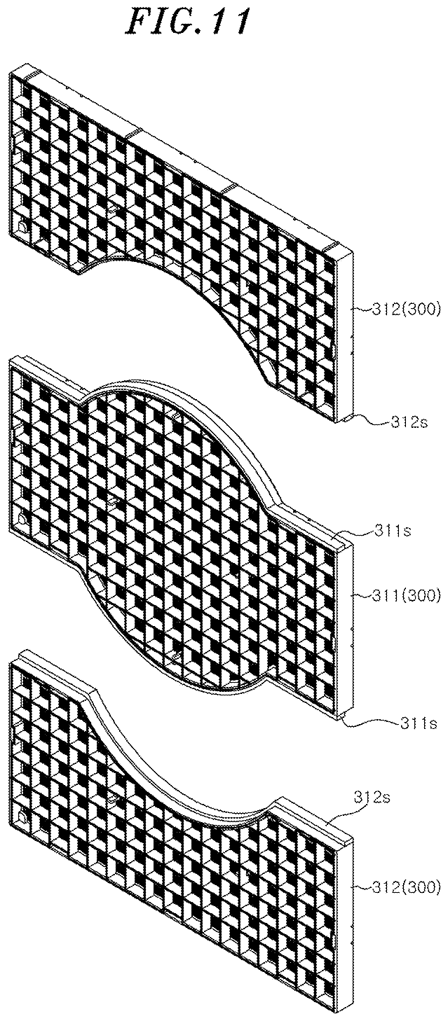

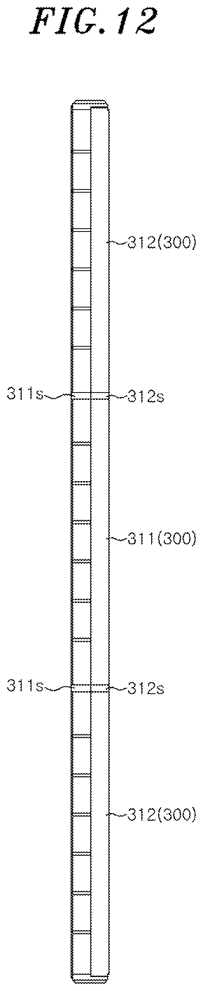

Hereinafter, an air purifier 1 according to a third embodiment of the present disclosure will be described with reference to FIGS. 11 and 12. The third embodiment is different from the above-described embodiments in that the first filter unit 311 and the second filter unit 312 have stepped portions formed along opposing edges. The following description focuses on explaining the differences, and the same description and reference numerals will refer to the above-described embodiments.

FIG. 11 is an exploded perspective view showing the filter module of the air purifier according to the third embodiment of the present disclosure. As shown in FIG. 11, the first filter unit 311 may have a first stepped portion 311s extending along at least a portion of the edge of the first filter unit 311. When the first filter unit 311 contacts the second filter unit 312, the first stepped portion 311s may be fastened to a second stepped portion 312s that will be described below. The first stepped portion 311s may have a shape corresponding to that of the second stepped portion 312s to prevent air from flowing between the first filter unit 311 and the second filter unit 312.

The second filter unit 312 may have the second stepped portion 312s that is formed along at least a portion of the edge of the second filter unit 312 to be fastened to the first stepped portion 311s. Further, when the second stepped portion 312s is fastened to the first stepped portion 311s, the first filter unit 311 can be prevented from moving along an air flow direction. For example, when the filter module 300 is installed in the air purifier 1 so that air flows from the front to the back of the filter module 300 to be filtered, the second stepped portion 312s may be located on the back side of the first stepped portion 311s. In other words, as shown in FIG. 12, when the first filter unit 311 is fastened to the second filter unit 312, the first stepped portion 311s and the second stepped portion 312s may be arranged so that at least a portion of the first stepped portion and at least a portion of the second stepped portion overlap each other in the air flow direction.

Hereinafter, the operation and effects of the air purifier according to the third embodiment of the present disclosure will be described.

Since the stepped portions 311s and 312s may be formed on the first filter unit 311 and the second filter unit 312 of the air purifier 1 according to the third embodiment of the present disclosure, it is possible to prevent air from flowing between the first filter unit 311 and the second filter unit 312. In addition, when the first stepped portion 311s is fastened to the second stepped portion 312s, it is possible to prevent the first filter unit 311 from moving in the air flow direction.

Although the present disclosure has been described above with reference to preferred embodiments, they are illustrative and not restrictive, and should be interpreted as having the widest scope consistent with technical idea disclosed in this specification. Those skilled in the art will implement the pattern of a shape that is not specified by combining/substituting the disclosed embodiments without departing from the scope of the invention. Further, it will understood by those skilled in the art that various modifications and changes may be made to the present disclosure without departing from the idea and scope of the present disclosure as set forth in the following claims.

1. A filter module installed in an air purifier to filter air, the filter module comprising:
a first filter unit; and a second filter unit detachably connected to the first filter unit and arranged to surround at least a portion of the first filter unit,
wherein the first filter unit comprises a shape-corresponding portion at least a portion of which is formed in a curved shape with a predetermined curvature,
at least a portion of an edge of the second filter unit is formed in a shape corresponding to the shape-corresponding portion, and
when the filter module is installed in the air purifier, an amount of air passing through the first filter unit per unit area is greater than an amount of air passing through the second filter unit per unit area.

2. The filter module of claim 1, wherein the first filter unit comprises an engaging portion,
the second filter unit comprises a fixing portion to engage with the engaging portion, and
the engaging portion and the fixing portion have a shape of a hook or a hole that engages with the hook.

3. The filter module of claim 2, wherein the first filter unit moves relative to the second filter unit in a predetermined fastening direction to be fastened to the second filter unit, and
the engaging portion and the fixing portion are configured to limit movement in the fastening direction when the first filter unit engages with the second filter unit, and
the fastening direction is parallel to a direction in which the air passes through the first filter unit and the second filter unit.

4. The filter module of claim 1, wherein the first filter unit and the second filter unit contain different filter materials to filter out different particles.

5. The filter module of claim 1, wherein the first filter unit comprises a first stepped portion that extends along at least a portion of an edge thereof,
the second filter unit comprises a second stepped portion that is formed along at least a portion of the edge thereof to be fastened to the first stepped portion,
the first stepped portion and the second stepped portion have corresponding shapes to prevent air from flowing between the first filter unit and the second filter unit, when the first and second stepped portions are fastened to each other.

6. The filter module of claim 5, wherein at least a portion of the first stepped portion and at least a portion of the second stepped portion are arranged to overlap each other in an air flow direction.

7. An air purifier comprising:
the filter module according to claim 1; and
a blower for providing a blowing force to cause external air to flow into the air purifier.

8. The air purifier of claim 7, wherein the blower comprises:
a blade that is rotatably driven; and
a blowing frame having an inlet port through which air is introduced by driving the blade,
the first filter unit is configured such that an area where the inlet port is projected onto the first filter unit is located in the shape-corresponding portion.
